(19) United States
(12) Patent Application Publication
(10) Pub. No.: US 2016/0018315 A1
(43) Pub. Date: Jan. 21, 2016

(54) NON-DESTRUCTIVE ADHESION TESTING OF COATING TO ENGINE CYLINDER BORE

(71) Applicant: GM Global Technology Operations LLC, Detroit, MI (US)

(72) Inventors: Yucong Wang, West Bloomfield, MI (US); Dale A. Gerard, Bloomfield Hills, MI (US)

(21) Appl. No.: 14/335,974

(22) Filed: Jul. 21, 2014

(51) Int. Cl. G01N 19/04

(52) U.S. Cl. CPC G01N 19/04

(57) ABSTRACT

Adhesion testing of coatings to the cylinder bore of an engine block. An adhesion testing fluid is dispensed from a nozzle that simultaneously rotates so that the fluid impinges about a substantial inner periphery defined by the coated cylinder bore. The performance of a referee coated engine block is used to provide parameters for one or more production-oriented engine blocks. This allows for rapid evaluation of a sizable sample of such production-oriented engine blocks. The fluid-dispensing nozzle is configured to simultaneously provide complete circumferential coverage of the cylinder bore with high-pressure/high-velocity fluid through rotational movement of the nozzle within the bore. By keeping the production-oriented engine blocks stationary during the test further improves testing efficiency.

This invention is related generally to the non-destructive testing of coated articles to determine the sufficiency of the coating's adhesion to the article, and more particularly to a simple, reliable, cost effective way to conduct such testing as part of a production-based process for a metal coated cylinder bore formed within an internal combustion engine cylinder block.

### BACKGROUND OF THE INVENTION

Components that are exposed to harsh environments (such as those encountered adjacent the combustion site of an internal combustion engine) would benefit from having their exposed surfaces covered with a protective coating. In one exemplary form, aluminum pistons may be coated with scuff and wear resistant metal coatings (often based on iron, nickel-tungsten, nickel-cobalt or the like) or nickel-ceramic coatings (such as those containing silicon carbide, silicon nitride or the like) to improve their wear and scuff resistance when running against wear-resistant aluminum cylinder bores. These coatings may be deposited by numerous techniques, including electro or electroless plating, while thermal spray coatings in particular may be applied to a cylinder bore for similar wear and scuffing resistance. In such configurations, the coating on the cylinder bore is usually much thicker (for example, 100 to 3000 micrometers) than that on the piston skirt (for example, 5 to 30 micrometers). Relatedly, the cylinder bore coating often requires post machining or horning while the piston coating does not. Both of these approaches have become an important surface treatment technology for internal combustion engine components, and are used by numerous automotive original equipment manufacturers (OEMs) for production versions of such engines.

Numerous well-known adhesion tests have been devised for evaluating the strength of the bond between the coating and the underlying substrate. Examples of such tests include: (1) the “tape” test wherein adhesive tape is applied to the coating and then pulled off normal to the surface to determine the tendency of the coating to either pull off with the tape or adhere to the substrate; (2) the “bend” test wherein a test sample is bent to a predetermined angle (for example, 90 degrees) to see if the coating cracks and bonds at the bend site; (3) the “stud pull” test wherein the coating is applied to a stud with an adhesive and the tensile stress required to separate the coating from the substrate is measured; (4) the “shear” test wherein the coated surfaces are adhered together and shear stress applied thereto until failure occurs; (5) the “microscratch” test wherein the coating is scratched with a particular tool under a particular load, and the scratch produced is characterized by a tool friction measurement, and acoustic emission detection and microscopy; and (6) the “grid blasting” test wherein a stream of air-borne glass beads (for example, SiO₂, Al₂O₃, or mixtures thereof) are impinged upon the coated part at a specified intensity in order to cause delamination, blistering or similar coating defects that display unacceptable adhesion to the underlying substrate. Of these, the grid blasting test is used most frequently in connection with production-based manufacture of coated components as a way to assess a significant percentage of mass-produced parts (such as those formed on an assembly line or the like) in order to screen out parts having unacceptable coating adhesion. In such a test, small beads (such as glass, ceramic or the like) are added to a high-velocity gas stream and impinged on the surface of the coated component.

Production line-based testing is an important way to test a statistically-significant number (for example, 10% or more) of the coated components as a measure of confidence that the deposition parameters consistently yield adequate coating adhesion. Because components such as the aforementioned cylinder bores and pistons are subsequently included in much larger (and hence, more expensive) assemblies, it is especially critical for OEMs to reduce the likelihood that an unsatisfactory component is placed into the assembly only to find out after significant value-added is built into the assembly that repair or replacement of the assembly may be required.

Because of its importance, production-based testing involves numerous steps to ensure that it is performed properly. Using grid blasting testing as an example, such steps may include: (1) cleaning the parts to be tested so that the glass beads do not become contaminated; (2) positioning the parts in a predetermined stand-off distance (for example, 4 inches) from the bead-dispensing nozzle; (3) setting the gas pressure (for example, 70 psi) for the air used to propel the glass beads; (4) impinging the beads against the parts to be tested for a predetermined time (for example, 4 seconds); (5) cleaning the glass beads from the tested parts; and (6) recycling the glass beads for reuse. Included among the disadvantages of such a process are: (a) the general undesirability of dealing with airborne ceramic beads in a plant environment where personnel and test and manufacturing equipment may be exposed; (b) time-consuming and costly pre-cleaning and post-cleaning of the parts before and after testing; and (c) wear on the equipment used to handle and propel the glass beads.

An effective way to test coating adhesion to pistons is disclosed in U.S. Pat. No. 5,454,260 (hereinafter the '260 patent) that is owned by the Assignee of the present invention and incorporated by reference in its entirety. Despite this, it is difficult to extend the '260 patent's testing of the coating adhesion of coated pistons to make it useful for testing the companion cylinder walls. This is especially problematic given the particular geometric features of the cylinder wall, where testing of the coating integrity deposited along the complete internal peripheral surface is required. In particular, although the water-ejecting nozzle and the piston of the '260 patent are capable of linear movement relative to each other (as well as individual water jet orifice rotation about a common jet axis), there is no discussion of the sort of rotational movement needed to ensure the circumferential testing of the cylinder wall. In fact, the approach used in the '260 patent uses rotational movement of the workpiece (i.e., piston) about a vertical axis that is generally parallel to (and horizontally offset from) the nozzle's linear movement axis. Such workpiece movement to accommodate the non-rotatable nozzle is not practical for large generally non-axisymmetric components such as a cast engine block. As such, there remains a need for having a cost-effective and reliable quality assurance method to test how well the coating is adhering to the wall that is formed by a cylinder bore within the engine block.

### SUMMARY OF THE INVENTION

This invention involves impinging a fluid (also referred to herein as a testing fluid) against a coating that has been applied to a cylinder bore as a way to test the adhesion and related durability of the coating. In a preferred form, the fluid is non-corrosive to the coating on the cylinder bore. In the present context, the term “cylinder bore” is construed to extend to those engine configurations where a liner or related insert, a layer of coating, or even the wall of parent block (i.e., where no coating or liner is present) is used to define the wall of the bore. The production-oriented engine blocks are made from either an aluminum alloy casting or an iron casting.

Specifically, the present invention involves preparing a reference standard by depositing a coating that has a minimum acceptable adhesion strength onto a reference substrate, One or more reference jets of fluid are directed from one or more corresponding nozzles against at least one site on the reference coating, and the impingement intensity of the jets are varied until a failure intensity is ascertained; in the present context, such a failure may coincide with the coating debonding from the substrate. In a preferred form, the impingement intensity of the jet (which is preferably discharging the fluid at supersonic speeds) is set at a predetermined “failure intensity” determined by testing of a sample having a minimum acceptable level of adhesion; in this way, coated parts that evidence no sign of scratching, debonding or the like are deemed to have passed the test, while those whose coatings debond when impacted by the jet fail the test.

According to an aspect of the present invention, a method of adhesion testing of a coating applied to an internal combustion engine cylinder bore is disclosed. The method includes preparing a referee coated cylinder bore to determine the intensity of an impinging fluid that results in failure of a coating applied to the cylinder bore, correlating that intensity with a minimum acceptable adhesion strength of the coating, and then rotatably impinging a high velocity fluid against a substantial circumferential entirety of a production-based coated cylinder bore. From this, indicia of damage to the coating on the production-based coated cylinder bore that has been subjected to the second impingement intensity is ascertained. Such indicia of damage (which may include one or more of debonding, spallation, pitting and delamination) may then be used to separate those engine blocks whose coating evidences the indicia of damage from those engine blocks whose coating does not. Significantly, by keeping the engine block that contains the bore substantially stationary at least during the high velocity fluid impinging, difficulties associated with block movement are avoided.

According to still another aspect of the present invention, a method of adhesion testing of a coating applied to at least one cylinder bore of an engine block includes determining a failure intensity of a high velocity testing fluid from a referee coated cylinder bore with a coating that defines a minimum acceptable adhesion strength, and impinging the high velocity fluid against a substantial circumferential entirety of a production-based coated cylinder bore that is substantially similar to the referee coated cylinder bore. The circumferential impinging takes place through rotational movement of a fluid jet nozzle that is placed within the production-based coated cylinder bore while the bore (and the engine block of which it forms a part) remains substantially stationary during the high velocity fluid impinging. The nozzle is configured to deliver a fluid jet impingement intensity that is substantially similar to the failure intensity. From this, indicia of damage to a coating on the production-based coated cylinder bore that has been subjected to the impingement intensity is acquired.

According to yet another aspect of the present invention, a method of adhesion testing of a coating applied to at least one cylinder bore of an engine block is disclosed. The method includes determining a failure intensity of a high velocity testing fluid from a referee coated cylinder bore where the coating defines a minimum acceptable adhesion strength. In addition, the method includes impinging the high velocity fluid against a substantial circumferential entirety of a production-based coated cylinder bore that is substantially similar to the referee coated cylinder bore. The circumferential impinging takes place through rotational movement of a fluid jet nozzle that is placed within the production-based coated cylinder bore while the bore and engine block remain substantially stationary during the high velocity fluid impinging. The fluid delivered through the nozzle has an impingement intensity that is substantially similar to the failure intensity. From this, indicia of damage to a coating on the production-based coated cylinder bore that has been subjected to the impingement intensity is acquired, after which those engine blocks whose coating evidences the indicia of damage are separated from those engine blocks whose coating does not.

### BRIEF DESCRIPTION OF THE DRAWINGS

The following detailed description of the preferred embodiments of the present invention can be best understood when read in conjunction with the following drawings, where like structure is indicated with like reference numerals and in which the various components of the drawings are not necessarily illustrated to scale:

FIG. 1 depicts a perspective view of a water-based linearly-movable testing device for piston coatings according to the prior art;

FIG. 2 depicts a plan view of a rotatably-movable testing device for cylinder wall coatings according to an aspect of the present invention;

FIG. 3 depicts an elevation view along section 3-3 of FIG. 2; and

FIG. 4 depicts a detail of the nozzle of FIGS. 2 and 3, including optional angular deviation of the fluid deposition away from the horizontal;

FIG. 5A depicts a simplified elevation cutaway view of the nozzle that delivers high pressure fluid, including two different sealing configurations; and

FIG. 5B depicts a plan view along section 5B-5B of FIG. 5A.

### DETAILED DESCRIPTION OF THE PREFERRED EMBODIMENT

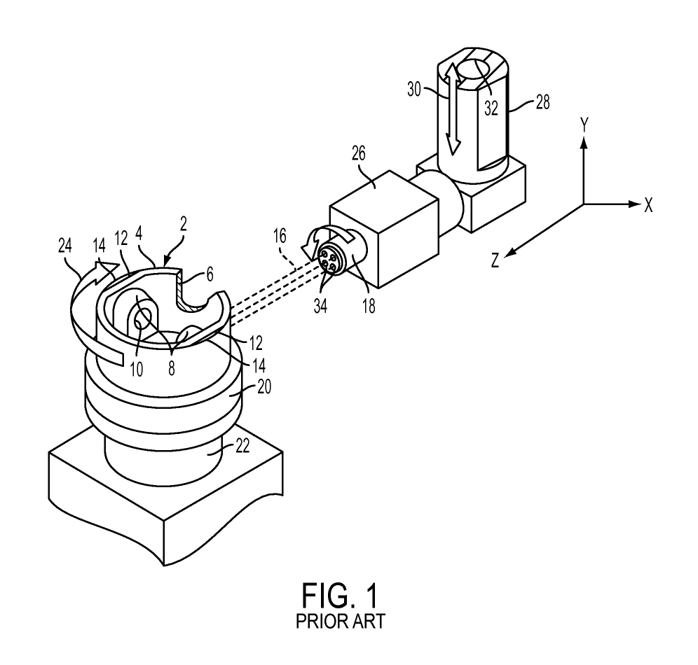

Referring first to FIG. 1, a coated piston testing device according to the prior art is shown. In it, a piston 2 with an exterior surface 4 having an electrodeposited protective coating 6 is subjected to supersonic jet 16 of water emanating from a nozzle 18 that is movable linearly 30 along vertical axis Y. The piston 2 is nested in a fixture 20 which, in turn, is mounted on a spindle 22 for effecting rotation of the piston 2 in the direction shown by the arrow 24 about the vertical axis Y. The nozzle 18 may be caused to be rotated at a high speed (for example, at about 1000 rpm) about the horizontal Z axis by means of a motor 26 both of which are carried by a hollow shaft 28 which moves up and down linearly 30. Pressurized water from a pump (not shown) is fed to the nozzle 18 through the hollow center 32 of the shaft 28. Typically, the supersonic water jet 16 will impinge on the external surface 4 of the piston 2 at an offset from the piston's vertical centerline such that an acute impingement angle (normally about 45°) is formed. The high pressure pump is capable of providing the supersonic jet (or jets) of water at very high pressures (for example, up to about 55,000 psi) to facilitate ejection from the one or more small orifices 34 that make up nozzle 18; however, the inability of the nozzle 18 to rotate in the X-Z plane about the substantially vertical Y axis that defines its travel path precludes comprehensive peripheral testing of the applied coating 6.

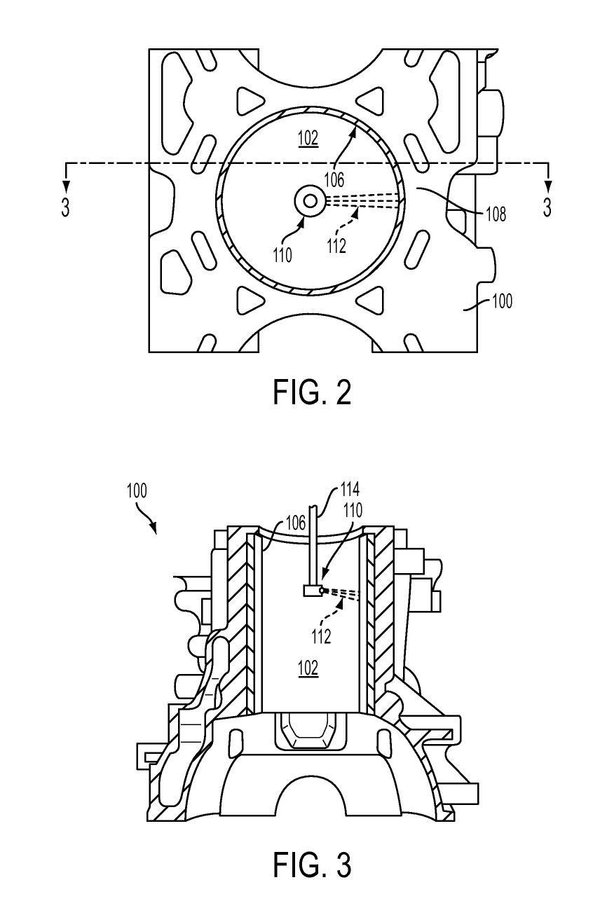

Referring next to FIGS. 2 through 5A and 5B, a device for conducting adhesion testing of a coating applied to at least one cylinder bore of an engine block according to one aspect of the present invention is shown. The present invention is preferably used as part of a production line-based manufacture of internal combustion engines in general and the walls or bores formed in cylinder blocks in particular. Furthermore, it is especially useful in bead-based testing systems, where the beads—whether glass, ceramic or a related material—are ejected as part of a fluid that impinges upon the coated surface. By having the fluid-ejecting nozzle (either with or without beads) rotate around the complete circumferential surface that is defined by the wall or bore, the approach of the present invention avoids the necessity of having the larger (and therefore more cumbersome) coated component be moved during the test. Moreover, by proper sealing and related fluid-containment design, otherwise harmful high pressure fluid leakage from the nozzle is reduced or eliminated.

A referee part in the shape of a cylinder bore 102 of an engine block 100 is first used as a way to determine whether a thermal spray protective coating 106 is sufficiently adherent to the wall 108 of the cylinder bore 102 to satisfy the intended use requirements of a subsequent production-based version of the engine block 100. Unlike testing and evaluation on externally-exposed components such as a piston 2 of FIG. 1 (where delamination is the most significant—and sometimes only—failure mechanism), the present inventors have observed that a thermal spray-coated cylinder bore 102 involves numerous others, including splat debonding, existing crack-initiated debonding and void-initiated debonding in addition to debonding between coating and substrate (where respectively the interface between overlapping splats, voids and cracks are the initiation sites for debonding in a manner different from that in plating-based coatings). Moreover, plated coatings such as those used on piston 2 are usually much thinner (for example, of the aforementioned 5 to 30 micrometer variety) than thermal sprayed coatings (i.e., the aforementioned 100 to 3000 micrometer variety) as used on cylinder bore 102. The failure is defined with a significant portion of the coating cracked, fractured and/or removed from the substrate. While these types of debonding may not be as patently obvious as the delamination-based failure mechanisms observed in coated piston 2, their effects upon the finished product cylinder bore 102 may be every bit as pronounced. To account for these differing failure mechanisms, the present invention features the ability to make a jetting nozzle 110 rotate in a full 360 degree pattern within the middle of the cylinder bore in a manner not possible with earlier adhesion testing devices.

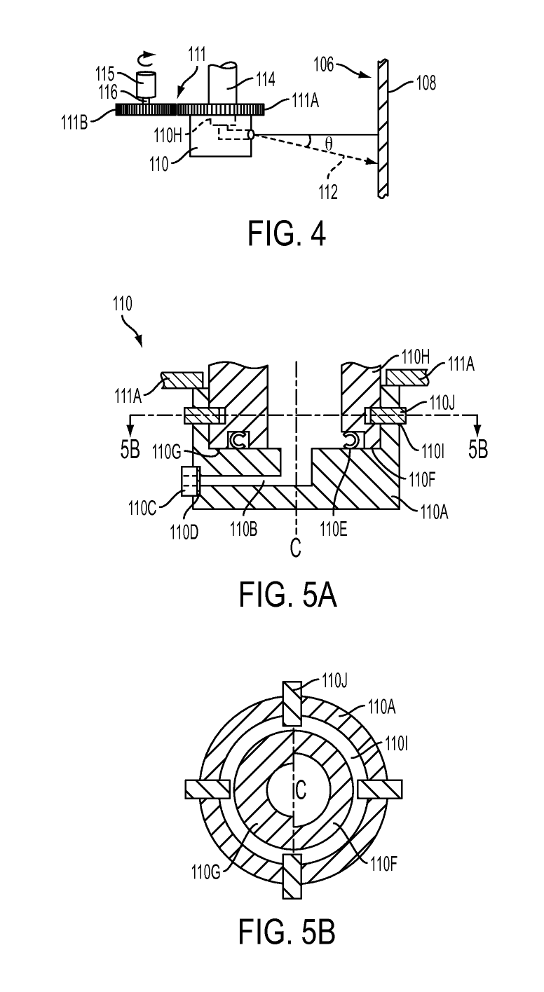

Referring with particularity to FIG. 4, in one form, such rotation can be imparted to the nozzle 110 without the necessity of rotating the adjacent end of a pressurized axial fluid conduit 114 that provides the pressurized fluid 112 to the nozzle 110. In particular, a geared coupling 111 between the nozzle 110 and a motor 115 establishes the necessary means for imparting rotation to the nozzle 110. The motor 115 imparts rotational movement to an attached shaft 116 that is secured to gear 111B; a suitable choice of either motor 115 speed or gearing ratio between the gears 111A and 111B can permit nozzle head 110A rotation with a desired speed, which in one preferred form may be between about 1 and about 100 revolutions per minute (RPM). It will be appreciated by those skilled in the art that other ways of providing selective rotational coupling to one part (specifically, head 110A) of nozzle 110 while leaving another concentrically-arranged part (specifically, coupling 110H) are possible, and that all such means are deemed to be within the scope of the present invention.

The referee part that corresponds to engine block 100 is prepared under controlled conditions to provide a quantifiable and sufficient level of adhesion of the desired coating 106. The standard established by this referee can then be used to set the intensity of an adhesion testing fluid through nozzle 110 through a substantial entirety of its complete 360 degree rotation R as part of its delivering high pressure (for example, between about 10,000 psi and 55,000 psi) adhesion testing fluid (also referred to herein as testing fluid, or more simply fluid) 112 to the inner circumference of the coating 106 on the wall 108. Significantly, the referee part is positioned in substantially the same manner (and using substantially the same fluid adhesion testing device) as the subsequent production-oriented parts to ensure that the same boundary conditions and related parameters are preserved in both. To promote robustness, the jetting nozzle 110 can be made of the combination of ceramic, metal and composite materials. In this way, water pressure losses due to sealing issues may be avoided. In particular, the high-pressure sealing design for the rotating function is also an important criteria.

Referring with particularity to FIGS. 5A and 5B, nozzle 110 is made up of a housing (or head) 110A, a fluid passageway 110B that converts the direction of fluid flow from an axial direction to a radially outward one, an outlet orifice 110C (which may be formed as a part of a separate insert as shown), an orifice seal 110D (in configurations where the orifice 110C is formed as a separate insert) and a metal seal 110E the latter of which forms a barrier between the head 110A and a coupling 110H that is cooperative with pressurized axial fluid conduit 114 to provide delivery of the high pressure testing fluid to the coated cylinder bore 102 via nozzle 110. In one form (not shown), the coupling 110H may be integrally formed as part of conduit 114; neither are to cooperative with the geared coupling 111A and 111B of FIG. 4 and as such remain stationary during the delivery of fluid 112 and the remainder of the adhesion testing of the coating 106. Numerous (for example, four) pins 110J are fixed in the head 110A and act as bearing surfaces to permit relative rotation between the coupling 110H and head 110A. The bearing surface provided by the pins 110J permits a sufficient degree of sliding contact between the facingly-adjacent surfaces of non-rotating coupling 110H and the gear-driven rotating head 110A. Referring with particularity to FIG. 5A, it can be seen that the gear 111A is decoupled by radial spacing from conduit 114 to emphasize that the rotation of the former is not imparted to the latter.

Because the testing fluid 112 being delivered through the nozzle 110 is of extremely high pressure, and further because the nozzle 110 needs to rotate about a full 360° arc defined by the inner surface of the coated cylinder bore 102, leakage control from the nozzle 110 becomes an important issue as a way to maintain accurate testing conditions. The seal 110E can withstand a pressure up to 55,000 psi at high temperatures (specifically, up to 700 C) while still permit relative rotation between the head 110A and the coupling 110H/conduit 114. This way, it provides sufficient leakage protection for the types of fluids 112 that are used in conjunction with the present invention. One way the present seal 110E delivers high pressure capability is through its shape and material choice that contribute to high spring-back properties and very low leakage rates. For example, seal 110E may be made from a nickel plated steel or a nickel-based material for enhanced corrosion resistance and high modulus of elasticity.

Two different configurations may be used for placement of the seals 110E between the head 110A and the coupling 110H, including the counterbore mode 110F (as shown on the right side of the centerline) and the groove mode 110G (shown on the left side of the centerline). The counterbore mode 110F is a little simpler to manufacture than the groove mode 110G; however, the groove mode 110G holds and protects seal 110E better. As such, the choice of which mode to use may be dictated by cost and pressure environment concerns Although the seal 110E is presently shown as being C-shaped, it will be appreciated by those skilled in the art that other seal configurations (such as an E-ring, O-ring, U-ring or wire ring) may also be used.

The nozzle 110 may include a single orifice 110C, or a number of them spaced about the periphery of the head 110A. In addition to adjusting the water jet pressure (which, as stated above, may range from about 10,000 psi to about 55,000 psi), the angle of the nozzle 110 may be vertically adjusted so that it impinges against the coating 106 by an angle θ up to about 15 degrees from the horizontal; such angling may be accomplished by pre-setting the angle θ through threaded, friction-fit or other manual tilt adjustment for each orifice 110C relative to head 110A, Moreover (and depending on the size of the cylinder bores 108 being evaluated), the spacing between the nozzle 110 discharge and the fluidly-coupled wall/bore 108 is about 1 to 2 inches. In one form, the orifices 110C defined within nozzles 110 have diameters of about 0.009 inch; depending on the number of such orifices (in one form, up to four); such sizes, number and pressures enable between about 1.2 to about 2.0 gallons per minute of liquid to flow during the coated cylinder bore 102 adhesion testing. Preferably, the arrangement of orifices 110C—which as mentioned above may in one form are spaced peripherally around the head 110A—remain stationary within the nozzle 110 head so that they maintain their position relative to one another through the movement of the head 110A; such an approach would make the system much simpler, as well as being more resistant to leaking, than if each orifice 110C were made to move independently. This is especially important in testing the thermal spray coating 106 in that its failure mechanisms react differently to the high velocity/high pressure testing fluid 112 than those of the plated coating 6 that covers the piston 2 of FIG. 1.

In one form, the velocity of the fluid 112 being dispensed from nozzle 110 may be a supersonic (i.e., greater than about 1088 feet/second) jet of liquid, such as water. Furthermore, such liquid may include corrosion-inhibiting additives. In situations where a bead-based stream is used to augment or otherwise define the fluid adhesion testing device, the beads may be mixed in with the pressurized fluid. In another form (discussed in more detail below), the fluid may be a gaseous medium (such as dry ice or the like). Regardless of the type of fluid 112, and regardless of the use/non-use of beads, the impingement intensity of the dispensed jet on the coating 106 from nozzle 110 may be increased in a controlled manner until blistering or debonding of the coating 106 occurs; such intensity is referred to herein as the “failure intensity” that can be measured so that when replicated on one or more production-oriented parts that corresponds to engine block 100, it provides indicia of when such a part is acceptable (i.e., one where the adhesion of the coating 106 is adequate to meet the performance requirement of the part) and when it is not. As such, the conditions used in the referee and the production parts are as close to identical as possible. The testing system (which in one form may be a station or related module that is formed as part of the production line (not shown) used to manufacture engine block 100) can be made to be cooperative with a stage gate in the production line such that those parts whose coatings debond from impingement of the fluid 112 are separated from those that do not; such separated substandard parts may then be either subjected to a recoating process or—in the case of where such recoating isn't feasible—discarded.

Significantly, the parameters associated with each coating 106 and substrate/bore wall 108 combination (including material composition, structure, thickness or the like) can lead to differing failure intensities, and as such will respond to the high pressure fluids 112 differently. Even so, once the variables that control the onset of the failure intensity are known and capable of being replicated (such as through the use of a programmable controller (not shown), it can then used as a basis to screen the adhesion of the coatings on the production-oriented parts that are being evaluated under the same conditions.

As mentioned above, fluids 112 other than pure water may be used as jetting media; such alternative materials may include mineral-based, as well as semisynthetic and synthetic-based ones, as well as water-based solutions. Semisynthetic and synthetic fluids combine the best properties of oil with the best properties of water by suspending emulsified oil in a water base. Significantly, one of these properties includes rust inhibition, while another is the increased tolerance of a wide range of water hardness (in essence helping to maintain the pH stability between about 9 to 10). Additional benefits may include the ability to work with many metals, as well as resist thermal breakdown and promote environmental safety.

While water is a good conductor of heat, its contact with some ferrous metal parts promotes rusting. As such, fluid 112 may be water-based but also include treatment systems to reduce its corrosivity. Such treatments may include neutralizing filters or chemical feed systems, the latter to add alkaline chemicals, the former to add calcium. In one form, such treatment system may include a tank (not shown) filled with calcium carbonate (limestone) chips, marble chips, magnesium oxide or other alkaline material. The acid neutralizing filter can also be used downstream of a pressure tank. In this way, raw water flows through the tank and as it contacts the media, its pH is increased to lessen that water's corrosive impact on the part that is exposed to the fluid 112. It is important to note that such a process will increase the hardness of the water; as such, the use of corrosion control and hardness needs to be weighed against one another. Corrosivity can also be treated by injecting a sodium hydroxide or soda ash solution using a chemical feed pump before the pressure tank. This treatment system is simple and inexpensive and it does not increase water hardness. Since the unit is installed ahead of the pressure tank, there is no reduction in water pressure that sometimes occurs with neutralizing filters. Of the two, soda ash is preferred over sodium hydroxide because it is safer to handle.

Mineral-based fluids, such as mineral oils that are similar to non-detergent motor oils (such as SAE 10 and 20 oils) may also be usable, although multi-weight motor oils with detergents and other additives are best avoided, as the additives can present a copper-corrosion concern to brass and bronze, which machine tools often have in their bearings and leadscrew nuts.

Also as mentioned above, fluid 112 need not be liquid. In one form, dry ice can be used, where it is made by a blasting process taking liquid carbon dioxide (CO₂) and expanding it to produce a snow like substance that is compressed to make hard dry ice pellets that is then allowed to expand; this in turn is accompanied by a drop in temperature sufficient to cause a change of phase into a solid. These solid crystals are redirected by either external nozzles (not shown, but generally similar to nozzles 110) or in a direct through-the-spindle delivery. These are then propelled at a supersonic speed by a compressed air gun (similar to a commercially available blasting system air gun). Upon impact, the extreme cold temperature of (i.e., about −80° C.) of the dry ice creates a micro-thermal shock which may break the bond between the coating 106 and the substrate and break the weak coating layer itself (with preexisting voids or cracks, weak bond among splats or the like). The high pressure air stream removes the dirt from the surface, while the dry ice pellets vaporize (sublimate). An adhesion testing approach using dry ice may have significant advantages relative to using sand, glass beads or other abrasives. For example, the dry ice avoids the use of solid particles that may contaminate cylinder bores 108. In addition, it reduces environmental contamination by leaving no waste to be disposed of. As such, both of these benefits help reduce production downtime and clean-up. In the present context, the use of the dry ice crystals—despite their solid nature—is considered to be a high velocity fluid, as the impingement of a large number of such crystals onto the coating 106 under the driving power of the high pressure air stream tends to mimic the delamination, blistering or related adhesion-disrupting effects of the other fluids mentioned herein.

Air or other gases (e.g., nitrogen) can also be used as a jetting media for fluid 112. Compressed air, supplied through pipes and hoses from an air compressor and discharged from a suitably-configured nozzle similar to nozzle 110. Liquid nitrogen, supplied in pressurized steel bottles, can be used in similar fashion. Of course, the parameters would need to be adjusted to ensure sufficient fluid 112 pressure for coating debonding. Likewise, modifications to the nozzle 110 (such as narrowing the nozzle, reducing its stand-off distance or lengthening the shooting time) help to create the needed high debonding powers sufficient to cause removal or damage to the coating 106.

The cylinder bores 108 are made from a material that is suitable for casting lightweight engine blocks; such materials are in one form iron-based materials, while in another aluminum-based materials with suitable alloying ingredients, particularly aluminum-silicon alloys such as Alloy 319, Alloy 356 and their respective variants. Proper alloy selection is important insofar as trying to match CTE of the bore or liner being coated with the protective coating helps manage the internal stress (tensile portion) of the coating (which in turn can lead to improved adhesion and related mechanical properties. Significantly, because CTE mismatches can be different for pistons than they are for cylinder bores, the coating adhesion measurements learned from one component may not extend to the other; this in turn will impact any “pass/fail” adhesion testing criteria and parameters. The proper understanding of component-specific coating adhesion and its resulting mechanical properties is therefore seen as an important distinguishing feature. As such, conclusions drawn for one component cannot be blindly extended to other components, even when such components are in the same operational environments (such as the piston and the cylinder bore or liner against which the piston reciprocates).

In one preferred form, testing according to an aspect of the present invention is performed without the need for pre-cleaning and post-cleaning of the coated part 100, In this way, this helps determine the sufficiency of adhesion between a coating 106 and the cylinder bore 108 substrate such that the process can be used as a production-based quality assurance tool to determine if a manufactured component is to be accepted or rejected. In another preferred form, the testing can be performed without the need for recycling of the beads discussed above. Also as mentioned above, while ceramic or other abrasive beads could be used, subsequent engine block 100 cleanup operations would become significantly more expensive to make certain that there is no hard particle contamination that could otherwise lead to engine failure. In still another preferred form, the fluid 112 that is impinging on the coated article avoids chemical interactions with the cylinder bore 102 substrate 108 and coating. 106 to reduce the chance of corrosive or otherwise harmful effects.

While hereafter the invention will be described and illustrated in connection with the testing of metal coatings on cast iron-based bore engines or cast aluminum-based bore engines (with or without iron-based liners), it is to be understood that it is equally applicable to other substrates and other coatings as well, and that the steps and principals embodied in the process are applicable to a wide variety of materials and shapes.

It is noted that terms like “preferably”, “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention, it is noted that the terms “substantially” and “approximately” and their variants are utilized herein to represent the inherent degree of uncertainty that may be attributed to any quantitative comparison, value, measurement or other representation. The term “substantially” is also utilized herein to represent the degree by which a quantitative representation may vary from a stated reference without resulting in a change in the basic function of the subject matter at issue.

Having described the invention in detail and by reference to specific embodiments, it will nonetheless be apparent that modifications and variations are possible without departing from the scope of the invention defined in the appended claims. In particular it is contemplated that the scope of the present invention is not necessarily limited to stated preferred aspects and exemplified embodiments, but should be governed by the appended claims.

We claim:

1. A method of adhesion testing of a coating applied to at least one cylinder bore of an engine block, said method comprising:
preparing a referee coated cylinder bore with a coating that defines a minimum acceptable adhesion strength;
impinging a first high velocity fluid against at least a portion of said referee and varying said first impingement intensity until a failure intensity is ascertained that substantially coincides with damage to said coating on said referee;
measuring said failure intensity; and
impinging a second high velocity fluid against a substantial circumferential entirety of a production-based coated cylinder bore, said circumferential impinging taking place through rotational movement of a fluid jet nozzle that is placed within said production-based coated cylinder bore that remains substantially stationary during said second high velocity fluid impinging, said fluid jet nozzle configured to deliver a second impingement intensity that is substantially similar to said failure intensity.

2. The method of claim 1, further comprising acquiring indicia of damage to a coating on said production-based coated cylinder bore that has been subjected to said second impingement intensity.

3. The method of claim 2, wherein said indicia of damage is selected from the group consisting of debonding, spallation, pitting and delamination.

4. The method of claim 3, wherein said debonding includes splat debonding, existing crack-initiated debonding and void-initiated debonding.

5. The method of claim 2, further comprising separating those engine blocks whose coating evidences said indicia of damage from those engine blocks whose coating does not.

6. The method of claim 1, wherein said first high velocity fluid and said second high velocity fluid comprise substantially the same constituent materials.

7. The method of claim 6, wherein at least one of said first high velocity fluid and said second high velocity fluid are pressurized to at least about 10,000 pounds per square inch upon exit from said nozzle.

8. The method of claim 7, wherein said fluid is a liquid.

9. The method of claim 8, wherein said fluid comprises water.

10. The method of claim 9, wherein said fluid further comprises a corrosion inhibitor.

11. The method of claim 7, wherein said fluid is a gas.

12. The method of claim 11, wherein said fluid is selected from the group consisting of air, nitrogen and combinations thereof.

13. The method of claim 7, wherein said fluid further comprises an abrasive medium added thereto.

14. The method of claim 13, wherein said abrasive medium comprises a plurality of beads.

15. The method of claim 7, wherein said fluid is a stream of dry ice crystals.

16. The method of claim 1, wherein said cylinder bore comprises a material made substantially of an aluminum-based alloy.

17. The method of claim 16, wherein said coating is a metal selected from the group consisting of iron and iron alloys.

18. A method of adhesion testing of a coating applied to at least one cylinder bore of an engine block, said method comprising:
determining a failure intensity of a high velocity testing fluid from a referee coated cylinder bore with a coating that defines a minimum acceptable adhesion strength;
impinging said high velocity fluid against a substantial circumferential entirety of a production-based coated cylinder bore that is substantially similar to said referee coated cylinder bore, said circumferential impinging taking place through rotational movement of a fluid jet nozzle that is placed within said production-based coated cylinder bore that remains substantially stationary during said high velocity fluid impinging, said fluid jet nozzle configured to deliver an impingement intensity that is substantially similar to said failure intensity; and
acquiring indicia of damage to a coating on said production-based coated cylinder bore that has been subjected to said impingement intensity.

19. The method of claim 18, wherein said cylinder bore comprises a material made substantially of a cast aluminum alloy.

20. A method of adhesion testing of a thermal spray coating applied to at least one cylinder bore of an engine block, said method comprising:
determining a failure intensity of a high velocity testing fluid from a referee coated cylinder bore with a coating that defines a minimum acceptable adhesion strength;
impinging said high velocity fluid against a substantial circumferential entirety of a production-based coated cylinder bore that is substantially similar to said referee coated cylinder bore, said circumferential impinging taking place through rotational movement of a fluid jet nozzle that is placed within said production-based coated cylinder bore that remains substantially stationary during said high velocity fluid impinging, said fluid jet nozzle configured to deliver an impingement intensity that is substantially similar to said failure intensity;
acquiring indicia of damage to a coating on said production-based coated cylinder bore that has been subjected to said impingement intensity; and
separating those engine blocks whose coating evidences said indicia of damage from those engine blocks whose coating does not.

21. The method of claim 20, wherein said cylinder bore comprises a material made substantially of a cast aluminum alloy.
